(19) United States
(12) Patent Application Publication
(10) Pub. No.: US 2008/0038175 A1
(43) Pub. Date: Feb. 14, 2008

(54) Method Of Working Up Liquid Substances

(76) Inventors: Jurgen Antes, Karlsruhe (DE); Dusan Boskovic, Karlsruhe (DE); Jurgen Haase, Waltrop (DE); Stefan Lobbecke, Karlsruhe (DE); Cornelius Ruloff, Leverkusen (DE); Tobias Turcke, Karlsruhe (DE)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/589,575

(22) PCT Filed: Feb. 16, 2005
(86) PCT No.: PCT/EP05/01525

§ 371 Date: Jul. 20, 2007

(30) Foreign Application Priority Data
Feb. 16, 2004 (EP) 10 2004 007 708.8

(51) Int. Cl. B01D 11/04; B01F 13/00

(52) U.S. Cl. 423/239.1; 23/306; 423/235

(57) ABSTRACT

The invention concerns a method for preparing liquid substances, whereby the preparation is made in one or several micro-reactors and/or micro-mixers, the liquid substance to be prepared being continuously mixed with a washing liquid in the micro-reactors and/or micro-mixers.

The invention relates to a method of working up liquid substances.

In many chemical methods, liquid substances are washed with other liquid substances. The liquid/liquid mixture obtained is then separated again into the individual liquid phases. In particular, in the preparation of liquid nitrate esters, such as nitroglycerol, a plurality of washes and phase separations is necessary during the working up of the crude products. This is described in greater detail using the example of nitroglycerol preparation.

After the reaction of nitrating acid with glycerol, a mixture of an acid phase and crude nitroglycerol is obtained, which mixture separates into two phases. In conventional plants corresponding to the prior art, this separation lasts from several minutes up to approximately 40 minutes. After draining off the acid phase, the still acidic crude nitroglycerol phase is washed while stirring 5 to 6 times with an aqueous and/or aqueously alkaline solution (for example, sodium carbonate solution) until the nitroglycerol obtained is acid-free and base-free. These phase separations each last again from several minutes up to approximately 40 minutes. Disadvantages of this procedure are the long phase separation times and, in particular, the large amounts of aqueous phase that have to be disposed of expensively. Thus, depending on the purity requirement, for example, per part by weight of nitroglycerol, up to 16 parts by weight of aqueous waste are produced. Similar problems exist generally in the working up and purification of liquid substances.

The object of the invention is therefore to overcome the disadvantages of the prior art and, in particular, to provide a method for working up liquid substances in which liquid substances are washed with one or more other liquid phases and wherein the liquid phases formed can be rapidly separated and only small amounts of waste are produced.

The object is achieved by a method of working up liquid substances, which method has the features of the main claim. Preferred refinements of the method according to the invention are to be found in the subclaims.

Microreactors and micromixers are extremely miniaturized tubular reactors having channel dimensions in the submillimetre range or volumes in the submillilitre range and are known per se. Descriptions are found, for example, in:

V. Hessel and H. Löwe, “Mikroverfahrenstechnik: Komponenten, Anlagenkonzeption, Anwenderakzeptanz”, (Microprocess technology: components, equipment design, user acceptance), Chem. Ing. Techn. 74, 2002, pages 17-30, 185-207 and 381-400.

J. R. Burns and C. Ramshaw, “A Microreactor for the Nitration of Benzene and Toluene”, in: Proceed. 4^{th} Int. Conference on Microreaction Technology (IMRET 4), 2000, Atlanta, USA.

S. Löbbecke et al., “The Potential of Microreactors for the Synthesis of Energetic Materials”, 31^{st} Int. Annu. Conf. ICT: Energetic Materials—Analysis, Diagnostics and Testing, 33, 27-30 Jun. 2000, Karlsruhe, Germany.

Basically, microreactors in which fluid flows are mixed with one another are suitable for the method according to the invention. Microreactors that employ the split-and-recombine principle or microreactors that employ the multilamination principle or microreactors that bring fluid flows into contact simply in a T-piece type of configuration may be mentioned here by way of example.

In a microreactor employing the split-and-recombine principle, fluid flows are split and brought together again after traversing different path sections. Repeating this flow configuration several times, for example in microchannels repeatedly disposed in parallel, results in efficient mixing of the liquid flows. The internal channel diameters of the microchannel structures of such microreactors are approximately 50 to 3000 μm. The length of the parallel microchannel structures may vary between 1 and 50 mm, preferably between 15 and 20 mm.

In a microreactor employing the multilamination principle, the individual fluid flows are first divided up into parallel lamellar flows before they are alternately combined and consequently mixed with the second multilaminated fluid flow. The internal channel diameters of the microchannel structures of such microreactors are approximately 50 to 3000 μm. The length of the parallel microchannel structures may vary between 1 and 50 mm, preferably between 15 and 20 mm.

The internal channel diameters of the microreactor may vary between 50 to 3000 μm. Preferably, internal channel diameters of 100 to 1000 μm and, very particularly preferably, of 200 to 300 μm are used.

In the case of working up in the microreactor, a laminar flow of the liquids is preferably employed. Particularly preferably, the Reynolds number is below 1000.

In the method according to the invention, microreactors are used that ideally contain microstructured passive mixing structures. However, simple T- or Y-mixers having comparable internal channel dimensions may also be used.

Preferably, microreactors using glass or silicon as material are used. In addition, reactors using materials of metal, ceramic or enamel can also be used.

According to the invention, provision may be made, in addition, for repeating the washing and separating operation as desired by connecting a plurality of identical or different microreactors (or micromixers) downstream of one another in series, and/or for carrying out different microreactor or micromixer washes one after the other (microreactor systems) by adding different washing liquids in each one.

Surprisingly, the mixture worked-up according to the invention leaving the microreactor and/or the micromixer and composed of liquid (valuable) substance and washing liquid is already separated into its phases. In this connection, the washing operation in accordance with the present invention is found to be substantially more efficient than in the case of a conventional method. Thus, the number of washing operations can be markedly reduced. The washing times and the consumption of washing liquid are reduced by up to 75%. Compared with the prior art, a markedly accelerated phase separation is achieved in the case of immiscible liquids.

According to the invention, the mixture that leaves the microreactor and/or micromixer and that is composed of liquid (valuable) substance and washing liquid preferably flows into a vessel having an upper and a lower drain so that the already separated liquid phases can be drawn off. In those cases in which a third phase is produced, they can be drawn off via one or more additional central vessel drains.

The method according to the invention is particularly suitable for working up nitrate esters. It is very particularly suitable for working up nitroglycerol.

The subject matter of the invention is explained in greater detail by reference to the following examples:

### EXAMPLE 1

### Working Up of Crude Nitroglycerol in Three Micromixers

The working up of crude nitroglycerol was performed in three micromixers that were composed of the material silicon and were connected in series. These mixers employ the split-and-recombine principle. In this connection, liquid flows are split up and, after passing through various paths, are brought together again. Repeating this flow conveyance several times in parallel microchannels results in an efficient blending of the liquid flows. The microchannel structures of the micromixers are approximately 200 to 300 μm in diameter. The length of the parallel microchannel structures varies between 15 and 20 mm. The micromixers were connected in series in such a way that the mixture leaving one micromixer was distributed over the two fluid inputs of the next micromixer by means of T- or Y-capillaries.

To perform the working up of crude nitroglycerol that can be obtained from a production process operating continuously or batchwise, this crude nitroglycerol was pumped with gas pressure (for example, nitrogen) from a container into one of the two educt channels of the first micromixer. Washing water was pumped into the second educt channel. The mass flow ratio of crude nitroglycerol to water was about 1:1.5. The mixture leaving the last micromixer and reaching the collection vessel was already separated into its phases immediately on leaving the micromixer so that nitroglycerol could be continuously drawn off from the collecting vessel via the lower drain. This crude nitroglycerol that had been washed once was again pumped by means of gas pressure into an arrangement of three micromixers connected in series and washed therein with dilute (5 wt %) soda solution in the mass flow ratio of crude nitroglycerol to soda solution of likewise 1:1.5. A phase separation again took place immediately after leaving the last micromixer. In a final washing step, the nitroglycerol phase was washed once again with water, as in the first washing step.

After the washing stages, the product stream was passed into a collecting vessel that contained an outlet at the top for the aqueous washing phases and one at the bottom for the washed nitroglycerol phase.

Owing to the phase separation occurring immediately on leaving the last micromixer, the sum of the dwell times in the micromixers is equal to the total washing time. The success of washing was determined in a known way by determining the stability time of the nitroglycerol phase in the Abel test and also by purity analyses (liquid chromatography). A conventional washing process performed macroscopically in which five washing stages (water, water, soda, water, water) were performed consecutively with a crude nitroglycerol/washing phase ratio of 1:3 (mass ratio) serves as a comparison. Table 1 summarizes the results. As a comparison, the working up in accordance with the prior art is specified in the row entitled “Conventional macroscopic” in Table 1. A comparison of the test results shows that, as a result of the use of the micromixers,
the absolute amount of washing solution can be reduced by up to 75%,
the number of washing steps can be reduced,
the net washing time can be drastically reduced,

stable nitroglycerol of high purity (cf. Table 2) is obtained.

TABLE 1

| | | | | | Nitroglycerol |
|---|---|---|---|---|---|
| | | Mass flow | | | stability after |
| | Number | (washing | | | washing in |
| | of | solution/ | Sequence | Dwell | micromixers (Abel |
| Type of | washing | nitroglycerol)/ | of washing | time per | method)/ |
| washer | stages | (g/min)/(g/min) | media | wash/s | min |
| Conventional | 5 | 3:1 | W/W/S/W/W | 300 | 10 |
| macroscopic | | | | | |
| Use of | 3 | 1.5:1 | W/S/W | 3 | 11 |
| micromixers | | | | | |

W: pure water;
S: 5% aqueous soda solution;
NGL: nitroglycerol

TABLE 2
Purity analyses of nitroglycerol after micromixer washings:

| | NO₂/ppm | NO₃/ppm | SO₄²⁻/ppm | Cl⁻/ppm | Na⁺/ppm |
|---|---|---|---|---|---|
| NGL after | 0.21 | 0.34 | 0.24 | 0.11 | 0.57 |
| micromixer | | | | | |
| washing | | | | | |

### EXAMPLE 2

### Working Up of Crude Nitroglycerol Using Nine Micromixers

The procedure corresponds to that in Example 1, but the crude nitroglycerol passed nine times consecutively through the system comprising of three micromixers connected downstream of one another. The first three washings were each performed with water, the second three washings were each performed with dilute (5 wt %) soda solution and, finally, the third three washings were again performed with water. The mass flow ratio of nitroglycerol to washing solution was 2:1. Table 3 summarizes the results. It is evident that a very high nitroglycerol stability was achieved.

As a comparison, the working up in accordance with the prior art is specified in the row entitled “Conventional macroscopic” in Table 3.

TABLE 3

| | | | | | Nitroglycerol |
|---|---|---|---|---|---|
| | | Mass flow | | | stability after |
| | Number | (washing | | | washing in |
| | of | solution/ | Sequence of | Dwell | micromixers (Abel |
| Type of | washing | nitroglycerol) | washing | time per | method) |
| washer | stages | (g/min)/(g/min) | media | wash s | min |
| Conventional | 5 | 3:1 | W/W/S/W/W | 300 | 10 |
| macroscopic | | | | | |
| Use of | 9 | 2:1 | WWW/SSS/WWW | 3 | 17 |
| micromixers | | | | | |

W: pure water;
S: 5% aqueous soda solution;
NGL: nitroglycerol

The results achieved in Examples 1 to 2 were also achieved under the same process conditions using other micromixers that contain passive mixing structures based on “split-and-recombine” or multilamination mixing principles.

1. Method of working up liquid substances, characterized in that the liquid substance to be worked-up is mixed continuously with a washing liquid in one or more microreactors and/or micromixers.

2. Method according to claim 1, characterized in that the internal channel diameter of the microreactor and/or micromixer is at least 50 μm.

3. Method according to claim 1, characterized in that the internal channel diameter of the micrometer and/or microreactor and/or micromixer is at least 100 μm.

4. Method according to claim 1, characterized in that the internal channel diameter of the microreactor and/or micromixer is not more than 3000 μm.

5. Method according to claim 1, characterized in that the internal channel diameter of the microreactor and/or micromixer is not more than 1000 μm.

6. Method according to claim 1, characterized in that the flow of the liquids in the microreactor and/or micromixer is laminar.

7. Method according to claim 1, characterized in that the flow of the liquids in the microreactor and/or micromixer has a Reynolds number of <1000.

8. Method according to claim 1, characterized in that the microreactor and/or micromixer contains microstructured passive mixing structures.

9. Method according to claim 1, characterized in that the microreactor and/or micromixer contains glass or silicon as material.

10. Method according to claim 1, characterized in that the microreactor and/or micromixer contains metal, ceramic or enamel as material.

11. Method according to claim 1, characterized in that the mixture that leaves the microreactor and/or micromixer and that is composed of liquid (valuable) substance and washing liquid flows into a vessel having an upper and a lower drain so that the already separated liquid phases can be drawn off.

12. Method according to claim 1, characterized in that, in addition to an upper and a lower drain, the vessel also has one or more additional drains via which further liquid phases can be drawn off.

13. Method according to claim 1, characterized in that the washing and separating operation is repeated by connecting a plurality of microreactors and/or micromixers downstream of one another in series and/or is varied by adding other washing liquids in each one.

14. Method according to claim 1 for working up liquid nitrate esters.

15. Method according to claim 1 for working up nitroglycerol.
